(19) United States
(12) Patent Application Publication
(10) Pub. No.: US 2005/0030734 A1
(43) Pub. Date: Feb. 10, 2005

(54) Personal decoration with retractable electroluminescent wire

(76) Inventors: David Botzer, Ramat Gan (IL); Michal Ganor, Kfar Saba (IL); Joseph Dvir, Mevaseret Zion (IL); Moshe Voskoboinik, Maale Adumim (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/634,891

(22) Filed: Aug. 6, 2003

(51) Int. Cl. F21V 9/16

(52) U.S. Cl. 362/84

(57) ABSTRACT

A novel device is presented having at least one electroluminescent element and a casing to house at least a portion of the electroluminescent element, allowing at least part of the electroluminescent element to be extracted from the casing and at least part of the electroluminescent element to be retracted into the casing.

### FIELD OF THE INVENTION

The present invention relates to electroluminescent devices generally and, more specifically, to electroluminescent wires.

### BACKGROUND OF THE INVENTION

The use of electroluminescent (EL) wires and EL strips for the purposes of personal decoration is known in the art. U.S. Pat. No. 5,485,355 (Voskoboinik), U.S. Pat. No. 5,869,930 (Baumberg) U.S. Pat. No. 6,082,867 (Chien), U.S. Pat. No. 5,479,325 (Chien), U.S. Pat. No. 5,676,451 (Tabanera), U.S. Pat. No. 5,956,071 (Feldman), US Patent Application No. 2001/0004808 (Hurwitz) and French Patent No. 2811206 (Simon), discuss the application of EL wires or EL strips to garments, clothing items, shoes and hats. In accordance with the prior art, the EL wires or EL strips are stitched, pasted or otherwise fixed to the object to be illuminated, for example, for decoration purposes. The power supply unit is typically stowed out of sight, for example, in a concealed pocket stitched into a clothing item or inside the heel of a shoe, and is thus not readily accessible.

Prior art devices are characterized by a predetermined length and shape, which may not be readily adjusted, but which may be irreversibly cut to size. Furthermore, the prior art devices do not facilitate easy access and rapid replacement of the power unit or units.

### SUMMARY OF THE INVENTION

Some exemplary embodiments of the invention provide a device incorporating an EL wire having adjustable features, e.g., length and shape, as well as convenient storage for an unused portion of the EL wire. Furthermore, exemplary embodiments of the invention enable easy access to a power unit of a device incorporating an EL wire.

According to some embodiments of the present invention, device may include an electroluminescent wire and a casing for housing at least a portion of the electroluminescent wire when not fully extended.

In accordance with further embodiments of the present invention, the device may further include couplers for coupling the EL wire to a desired location on an object, for example a clothing item. Once positioned at the desired location, the couplers may be locked in place. The couplers may then be released and repositioned as desired. According to further embodiments of the present invention, the couplers may be slid or otherwise moved along the EL wire. Once positioned at the desired location along the EL wire, the coupler may be locked in place. The coupler may then be released and repositioned at a new location of choice along the EL wire. Thus, in accordance with some embodiments of the present invention, the EL wire may be used to form a variety of shapes in a variety of sizes simply by adjusting the position of the coupler on the object to which the EL wire is to be coupled, and/or the location of the couplers along the EL wire.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following non-limiting detailed description of embodiments of the invention when read with the accompanied drawings in which:

FIG. 1 is an top view of a device including an EL wire and a casing, in accordance with some embodiments of the present invention;

FIG. 2 is an isometric, exploded-view, illustration of a device including a coil spring for automatically retracting at least a portion of an EL wire into a casing, in accordance with further embodiments of the present invention;

FIG. 3 is a schematic illustration of a power supply unit having two EL wires operatively connected thereto, in accordance with some embodiments of the present invention;

FIG. 4A is a schematic front view illustration of an EL wire device incorporating a set of couplers, in accordance with some exemplary embodiments of the present invention;

FIG. 4B is a schematic side view illustration of the device of FIG. 4A;

FIG. 5A is a schematic cross-sectional, back-view, illustration of a coupler attached to an EL wire in accordance with some exemplary embodiments of the present invention;

FIG. 5B is a schematic cross-sectional, side view, illustration of the coupler of FIG. 5A; and

FIG. 5C is a schematic front-view illustration of the coupler of FIG. 5A;

It will be appreciated that for simplicity and clarity of these non-limiting illustrations, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods and procedures have not been described in detail so as not to obscure the present invention.

Throughout the specification and the claims, the term “spool” is used to denote a substantially cylindrical element around which an electroluminescent wire may be wound. However, it should be noted that the present invention is not limited in this respect, and other elements, providing similar functionality, may be used as part of some embodiments of the present invention, including but not limited to a bobbin, a disc and a spool.

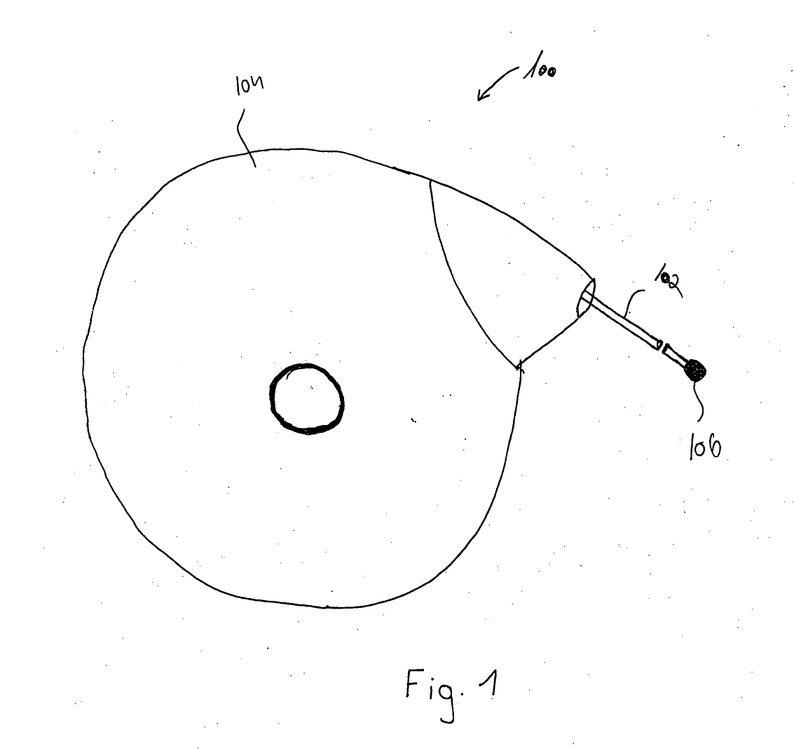

Reference is now made to FIG. 1, which schematically illustrates a top view of a device 100 including an EL wire and a casing, in accordance with some embodiments of the present invention.

The device 100 may include an electroluminescent (EL) wire 102 and a casing 104. The EL wire 102 may be retracted into the casing 104. The casing 104 may be used for housing at least a portion of the EL wire 102. In the embodiment shown, a portion of the EL wire 102 is extended out of the casing 104.

In accordance with some embodiments of the present invention, the length of the EL wire 102 extending out of the casing 104 may vary, and may be, for example, determined by a user. According to further embodiments of the present invention, the EL wire 102 may be fully or partially extended out of the casing 104, as desired. It should be noted that when the phrase “fully extended” or a similar phrase is used to describe the extension of the EL wire 102 out of the casing 104, it may not necessarily refer to a complete extraction of the EL wire 102 from the casing 104. Rather, possibly, when the EL wire 102 is fully extended, a generally small portion (not shown in FIG. 1) of the EL wire 102 may remain inside the casing 104. The portion of the EL wire 102 inside the casing 104 may be used for anchoring or otherwise connecting the EL wire 102 to one or more elements inside the casing 104.

Some embodiments of the present invention may include a mechanism for preventing the extended EL wire 102 from retreating into the housing 104. In the exemplary embodiment shown in FIG. 1, the device 100 may include a stopper 106. The stopper 106 may be adapted to prevent the EL wire 102 from being completely retracted into the casing 104, leaving at least an exterior end of the EL wire 102, connected thereto, out of the casing 104. Thus, the stopper 106 may allow convenient grasp of the EL wire 102 even when the EL wire 102 is in a fully retracted mode. The EL wire 102 may be readily extended as desired by pulling the stopper 106 or any part of the EL wire 102 protruding out of the casing 104. The extension and retraction of the EL wire 102 in various embodiments of the invention will be discussed in greater detail hereinbelow.

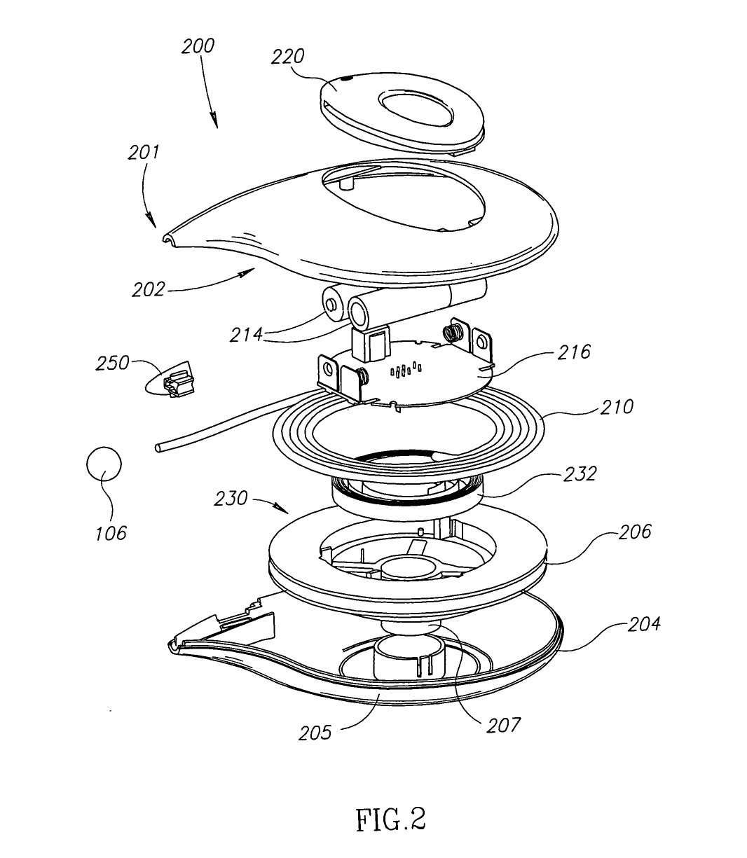

Reference is now made to FIG. 2, which is an illustration of a device including a coil spring for automatically retracting at least a portion of an EL wire into a casing, in accordance with embodiments of the present invention. The device 200 may include a casing 201. The casing 201 may include a first casing frame 202 and a second casing frame 204. The device 200 may further include a rotatable spool 206, which may be fitted into the casing 201 in a manner that enables rotation of spool 206 within casing 201, as discussed in detail below.

For example, a portion of the casing frame 204 and the rotatable spool 206 may be engaged or coupled such that spool 206 may rotate For example, the second portion of the casing 204 may have a bore 205. The rotatable spool 206 may have a shaft 207. The shaft 207 may be fitted into the bore 205 in a manner to allow the rotatable spool 206 to rotate around a central axis of the shaft 207. According to one embodiment, the shaft 207 may include a bearing (not shown). According to further embodiments of the present invention, the spool 206 may be otherwise fitted or coupled to a portion of the casing 201. According to embodiments of the present invention, the device 200 of the present invention may be otherwise designed to enable rotation of rotatable spool 206 in casing 201, e.g., using suitable methods known in the art.

The device 200 may further include an EL wire 210. The EL wire may be any EL device, for example, as described in U.S. Pat. No. 5,485,355 (Voskoboinik) or U.S. Pat. No. 5,869,930 (Baumberg). It will be understood that the EL wire used in conjunction with embodiments of the present invention may utilize any flexible EL device, such as EL strip, three-dimensional EL wire, EL tube, EL welt, etc. The EL wire 210 may be wound around the rotatable spool 206. According to some embodiments of the present invention, the peripheral portion of the spool 210 may have a channel-like design. When retracted, the EL wire 210 may be wound around the spool 206 within the channel. The dimensions of the channel may be sufficient to hold several windings of the EL wire 210 around the spool 206. In some embodiments, the channel may be large enough to hold the full length of the EL wire 210.

According to some embodiments of the present invention, the device 200 may further include at least one power supply unit 214, such as a battery. The at least one power supply unit 214 may be operatively connected to a printed circuit board (PCB) 216. One end of the EL wire 210 may also be operatively connected to the PCB 216. Thus, the EL wire 210 may receive power from the power supply unit 214 through the PCB 216. The PCB 216, together with the power supply unit 214 coupled thereto, may be mounted or otherwise engaged with the rotatable spool 206. When engaged, the spool 206, the PCB 216 and the power supply unit 214 may all rotate as a single unit. The coordinated movement of the spool 206 and the power supply unit 214, either directly or through the movement of the PCB 216, may enable continuous contact between the EL wire 210 and the power supply unit 214. The continuous connection between the EL wire 210 and the power supply unit 214 (possibly through the PCB 216) may enable a continuous supply of power to the EL wire 210 at all times, whether extended, retracted or during extension or retraction.

A portion of the casing 201, for example, the first casing frame 202 may include an openable cap or latch 220. When the openable cap 220 is closed, the inside of the casing 201 may be inaccessible from the outside. However, removal or otherwise opening the openable cap 220 may expose at least a portion or portions of the inside of the casing 201, and provide access to one more elements of the device 200. Thus, by opening the cap 220 a user may be capable of adding, removing, replacing or modifying, or the like, one or more of the elements of the device 200.

In one embodiment of the present invention, openable cap 220 may enable access to a connection point or points (e.g. a set of output terminals) of one or more EL wires 210 to the power supply unit 214. Thus, by opening the cap 220 a user may add, remove, replace or modify, or the like, each of the one or more EL wires 210. The user may select to add additional EL wires 210, or replace the EL wires currently utilized by the device as desired. The additional or replacement EL wire 210 or wires may have different colors, different length, different width, etc. The addition of EL wires 210 and the connection of the additional wires, either in parallel or serially will be discussed in greater detail hereinbelow. Those of ordinary skill in the art may appreciate that the use of an openable cap or lid 220 may enable enhanced maintenance and serviceability capabilities, as well as added value features, for example, by enabling a user to replace dead or empty batteries with new ones, connect additional EL wires in parallel or in serial, connect additional unit or units for enabling additional features, etc.

According to further embodiments of the present invention, the cap or lid 220 may also be used as a power switch. In one embodiment, the cap 220 may be rotated between a first state and a second state. When in the first state, the cap 220 may be adapted to disconnect the power supply unit 214 from one or more elements of the circuit (e.g. from the EL wire). Whereas, when the cap 220 is rotated to the second state, the power from the power supply unit 214 may be connected to the rest of the circuit. Thus, when the cap 220 is rotated to the first state, the active elements of the device (e.g. the EL wires) may be deactivated, and may be activated when the cap 220 is rotated to the second state. The cap 220 may enable the selection of additional operation modes in accordance with a variety of additional power schemes. For example, in one embodiment, the cap 220 may be rotated to a third state, causing the power supply unit 214 to be connected and disconnected from one or more elements of circuit (e.g. to the EL wire) in rapid succession. In the third state a flashing effect may be provided, whereby the EL wire 210 may repeatedly flash on and off. Those of ordinary skill in the art may appreciate that the cap 220, or any other power switch known in the art, may be designed to rotate between numerous states including, the states discussed above, as well as additional states, for providing a selection between numerous power schemes.

In one embodiment, the device 200 may include an intensity control unit (not shown) to control the intensity of the power to be delivered to one or more elements of the circuit. The intensity control unit may be connected to the power supply unit 214 and/or to any to additional intermediary elements the circuit (e.g. the PCB). The power intensity may be adapted to control one or more aspects of the operation of an element or elements of the circuit. For example, by adapting the power intensity delivered to EL wire 210, the luminescence of EL wire 210 may be modified. Thus, a user may be capable of adapting the EL wire's 210 luminescence intensity to comply with current needs. In addition, by adapting the power intensity, the power consumption of the device 200 may be optimized. The intensity control unit may be manually controlled by a user, or may be controlled automatically in accordance with predefined criteria (e.g. the intensity of ambient light). Any suitable intensity control unit or units or any suitable elements may be used including any combination of suitable elements or units.

In accordance with further embodiments of the present invention, the openable cap 220 may expose only a portion of the areas within the casing 201, and/or may provide access to only specific element or elements located within the casing 201. Furthermore, the inner cavity of the casing 201 may be divided to one or more chambers or compartments. Each chamber or compartment may contain one or more elements of the device 200. Each compartment may be designed to fulfill a specific functionality or functionalities. The functionality may be associated with the element or elements of the device positioned within the compartment. For example, the device 200 may include a power unit compartment for storing and utilizing a power supply unit 214, such as batteries. The power unit compartment may be, for example, designed to retain the power supply unit 214 in electrical contact with the active elements of the device 200, such as the EL wire 210, under various conditions and operation modes. Each of the compartments may be physically separated from the other compartments. In addition, one or more of the compartments may also include an openable cap or lid 220, which may provide access to one or more elements positioned within the one or more compartments.

According to some embodiments of the device of the present invention, the EL wire 210 may be manually retracted into the casing 201. In one exemplary embodiment, the device 200 may include a manual retraction mechanism (not shown). The manual retraction mechanism may include a revolving handle. The handle may be operatively connected to the spool 206. The handle may be revolved at least in a first direction, causing the spool 206 to also rotate in the first direction, thereby pulling or otherwise retracting the EL wire 210 into the casing 201. According to further embodiments of the device of the present invention, the handle may also be revolved in the counter direction causing the spool 206 to rotate in a second direction, opposite to the first direction, thereby extending the EL wire 210 out of the casing 201.

In accordance with the embodiment shown in FIG. 2, the device 200 may also include an automatic retraction mechanism 230. The automatic retraction mechanism 230 may be operatively connected to the spool 206. The automatic retraction mechanism 230 may be adapted to cause the spool 206 to rotate in a first direction, thereby pulling or otherwise retracting the EL wire 210 into the casing 201.

According to further embodiments of the device of the present invention, the device 200 may also include an automatic extension mechanism (not shown). The automatic extension mechanism may be adapted to cause the spool 206 to rotate in a second direction, opposite to the first direction, thereby extending the EL wire 210 out of the casing. The automatic extension mechanism may be constructed similarly to the automatic retraction mechanism discussed above. For example, the automatic extension mechanism may also include a spring. The spring of the automatic extension mechanism may be configured conversely to the configuration of the spring of the automatic retraction mechanism, as will be discussed in greater detail hereinbelow.

However, it should be noted that the automatic retraction mechanism and/or the automatic extension mechanism may include any other suitable elements either in addition or in alternative to a spring, including but not limited to, motors, magnets etc. The automatic retraction mechanism and the automatic extension mechanism may conjointly use or more of the elements of the other mechanism. The operation of the automatic retraction mechanism and/or of the automatic extension mechanism may also affect the operation of one or more of the elements of the other mechanism. Furthermore, in accordance with some embodiments of the device of the present invention, the device may include any suitable combination of manual and automatic retraction and/or extension mechanism or any combination thereof.

Referring back to FIG. 2, the spring 232 may be used for automatically winding and/or retracting the EL wire 210 into the casing 201. The spring 232 may be configured to allow a user to extend the EL wire 210 or any portion thereof, simply by pulling the wire 210 out of the casing 201. The spring 232 may be adapted to automatically retract the EL wire 210 upon the release of the EL wire 210. A first end of the spring 232, for example the inner end, may be connected to the casing 201. For example, the first end of the spring may be connected to the second portion of the casing 204. The second end of the spring 232, for example the outer end, may be connected to the rotatable spool 206. As a result, when the spool 206 is rotating in a first direction, for example in response to a force pulling the EL wire 210 out of the casing 201, the second end portion of the spring 232 may also rotate with the spool 206. Since the first end of the spring 232 may be anchored to the casing 201, the spring 232 may be gradually wound. When the EL wire 210 is released the spring 232 may spontaneously begin to unwind. The unwinding of the spring 232 may cause the spool 206 to rotate in the opposite direction, and the EL wire 210 to coil around the spool 206. Thus, at least partial automatic retraction of the EL wire 210 may be achieved. It should be noted, that in order to guarantee sustained and full retractability of the EL wire 210 over time, it may be desirable to configure the spring 232, such that some redundant load is applied onto the spool 206 even when the EL wire 210 is substantially completely retracted. In such cases, it may be beneficial to use a stopper 106 which may prevent the EL wire 210 from being completely retracted into the casing 201.

In addition, in accordance with some embodiments of the present invention, the device 200 may further include a lock 250. The lock 250 may be configured to lock the EL wire 210 in place, for example, by friction, preventing any further extension and/or retraction of the EL wire 210. The lock 250 may be slid or otherwise moved between two states, a locked state and a released state. When the lock 250 is in a locked state, the EL wire 210 may be locked and may not be further extended and/or retracted. When the lock 250 is in a released state the EL wire 210 may be freely extended and/retracted. According to further embodiments, when in the locked state the lock 250 may permit the EL wire 210 only to be retracted and prevent any further extension of the EL wire 210, and vice versa.

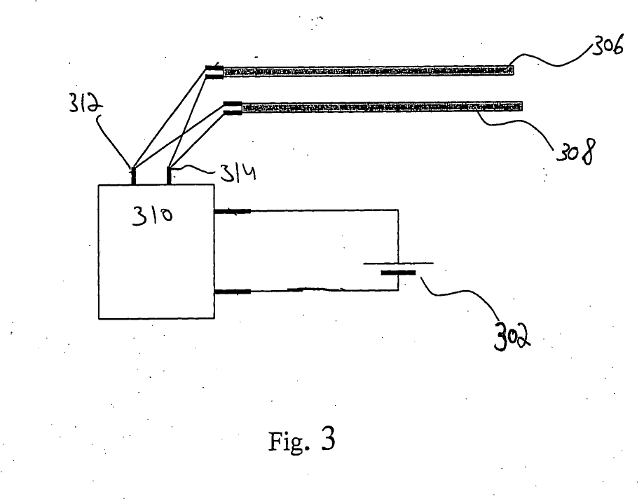

Reference is now made to FIG. 3 showing a power supply unit having two EL wires operatively connected thereto, in accordance with some embodiments of the present invention. The power supply unit 302 may be connected to two or more distinct EL wires 306 and 308, through an inverter 310. The inverter 310 may be adapted to modify some characteristics of the power that is to be applied therethrough to the EL wires 306 and 308. For example, the inverter 310 may be adapted to the convert the direct current (DC) output to an alternating current, which is to be input to one or both of the EL wires connected thereto. The inverter 310 may be adapted to modify other characteristics of the power to be applied to the EL wires 306 and 308. The inverter 310 may be constructed using any known in the present or yet to be devised in the future electronic or other power modification and/or transmission elements.

The EL wires 306 and 308 may be connected to the power supply unit or units 302 either serially or in parallel or in any combination thereof. In case that several (e.g. two or more) EL wires are connected to the power supply unit 302 serially, the result may be an extended EL wire (not shown) having several sections, wherein each section may correspond to one or more of the EL wires. Each section of the extended EL wire may have distinct characteristics. For example, an extended EL wire may be provided, wherein two or more sections of the wire may be adapted to emit a different color of light. The extended EL wire may be used to form larger and/or more intricate multicolor shapes. According to some embodiments of the device of the present invention, at least one of the EL wires connected to the power supply unit may be adapted to connect to at least one additional EL wire serially. For example, the tip of the portion of an EL wire connected to the power supply unit may include output terminals. The electrodes of an additional EL wire may be engaged or otherwise connected to the output terminals of the EL wire, thereby serially connecting the additional EL wire to the power supply unit. The additional EL wire may be removed simply by disconnecting the electrodes of the additional EL wire from the output terminals of the EL wire connected to the power supply unit. This may be done for example, by pulling the additional EL wire away from the EL wire.

A different result may be achieved by connecting several (e.g. two or more) EL wires 306 and 308 to the power supply unit 302 in parallel. When connecting the EL 306 and 308 wires in parallel, the result may be several distinct EL wires 306 and 308. Each of the distinct EL wires 306 and 308 may have distinct characteristics (e.g. different colors). In addition, each of the EL wires 306 and 308 may be used individually, to form a variety of distinct shapes in a variety of sizes. The EL wires 306 and 308 may be individually or jointly operated. According to some embodiments of the device of the present invention, the power supply unit 302 may be configured to connect to more than one EL wire in parallel. According to further embodiments of the present invention, the inverter 310 may be adapted to connect more than one EL wire to the power supply unit 302 in parallel. The inverter 310 may include two or more sets of output terminals 312 and 314. Two or more corresponding EL wires 306 and 308 may be individually connected in parallel to each of the available sets of terminals 312 and 314.

According to some embodiments of the device of the present invention, newly added EL wires, whether connected serially or in parallel may also be retracted into the casing in a manner similar to the device for one EL wire. The EL wires may be retracted and/or extended either individually or jointly. When not fully extended the portion of the additional EL wire, which is not extended, may be stored inside the casing.

According to further embodiments of the present invention, the device may enable a user to modify certain aspects of the operation of the device, for example, by adding, subtracting or combining EL wires in series or in parallel. Other aspects of the operation of the device may also be modified by controlling some aspects of the operation of other elements of the device. For example, certain aspect of the operation of the inverter may be modified to influence the operation of the EL wires. The operation of the elements of the device may be controlled either manually, by and operator, or automatically, by a controller, or by any combination thereof.

In accordance with some embodiments of the present invention, power consumption of 1 meter of Lytec® 01S BG EL wire, manufactured by ELAM Electro-Luminescent industries Ltd. of Har-Hotzvim, Israel, at a voltage of 100V and a frequency of 800 Hz is around 2 mA. In accordance with these parameters, the luminosity of the Lytec® EL wire is in the order of 50-60 cd/m². Two M batteries may provide sufficient power to activate a single EL wire in accordance with the above parameters, for a duration of approximately 25 hours. Those of ordinary skill in the art may compute a variety of values associated with different aspects of the operation of the device in accordance with embodiments of the present invention, and in accordance a variety of operational inputs and parameters.

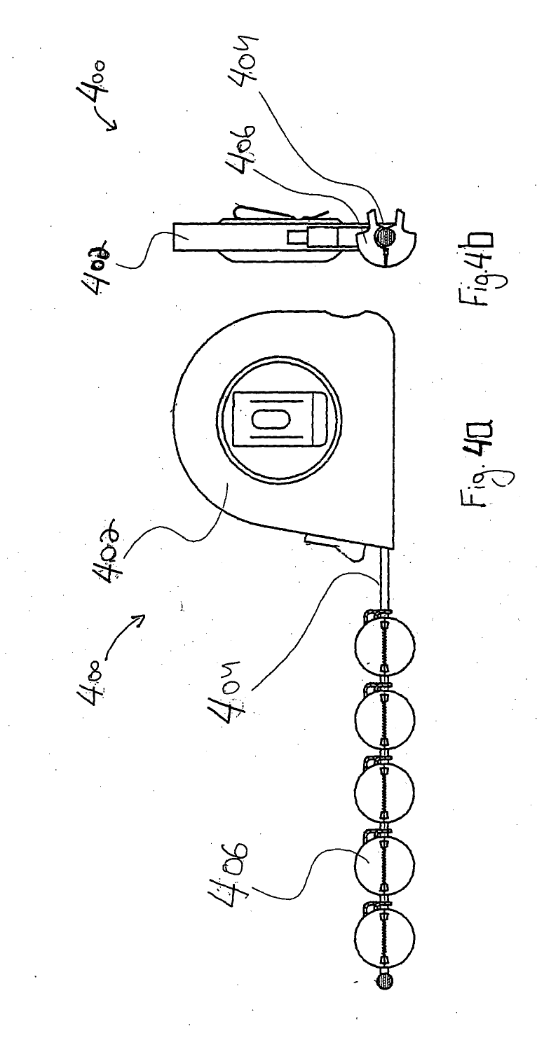

Reference is now made to FIG. 4A, showing a front view of an EL wire device incorporating a set of couplers, in accordance with some exemplary embodiments of the present invention. In addition, reference is made to FIG. 4B, showing a side view of the device of FIG. 4A. The device 400 may include a casing 402, an EL wire 404 and one or more couplers 406. The casing 402 may be used for housing at least a portion of the EL wire 404 when not fully extended (not shown). In the embodiment shown, a portion of the EL wire 404 is extended out of the casing 402. The couplers 406 may be placed or otherwise positioned on the portion of the EL wire 404 that is extended out of the casing 402. The couplers 406 may be adapted to couple the EL wire 404 to one or more objects (e.g. clothing, shoes, etc.). The couplers 406 may be suitable for coupling the EL wire 404 to a variety of different objects having different characteristics. Alternatively, specific couplers 406 may be selected to couple the EL wire 404 to a specific object having predetermined characteristics, size and/or shape. Once positioned at the desired location, the couplers 406 may be locked, thereby coupling the EL wire 404 to the object. The couplers 406 may then be released and repositioned as desired and locked again to couple the EL wire 404 to the object at the new location.

According to further embodiments of the present invention, the couplers 406 may be slid or otherwise moved along the EL wire 404. The couplers 406 may then be locked, thereby fixing the coupler to a specific location along the EL wire 404. The couplers 406 may be released and moved to a new location along the EL wire 404 and then locked again, as desired. Thus, in accordance with some embodiments of the present invention, the EL wire 404 may be used to from a variety of shapes in a variety of sizes simply by adjusting the position of the couplers 406 on the object to which the EL wire 404 is to be coupled, and/or the location of the couplers 406 along the EL wire.

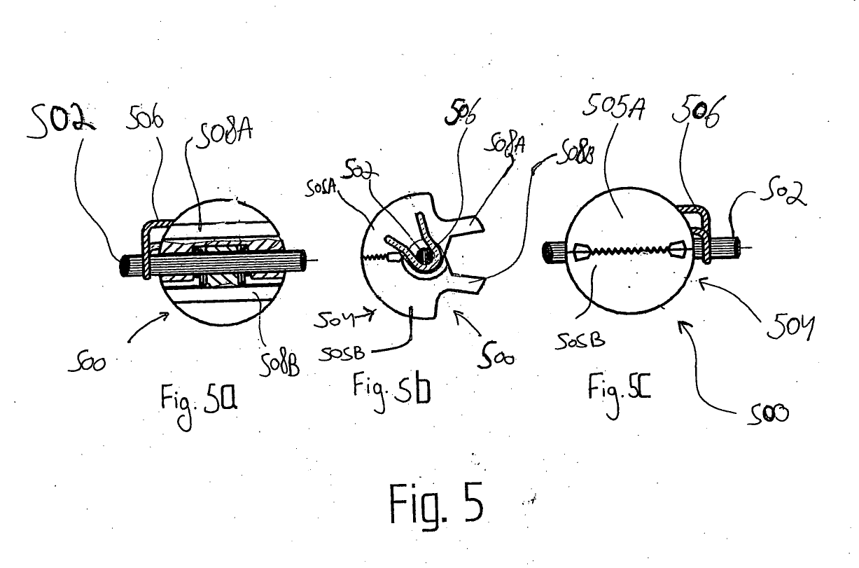

Reference is now made to FIG. 5A, showing cross-sectional, back-view, of a coupler attached to an EL wire in accordance with some exemplary embodiments of the present invention, to FIG. 5B, showing a cross-sectional, side view of the coupler of FIG. 5A and to FIG. 5C, showing a front-view illustration of the coupler of FIG. 5A. The front portion of the couplers 500 may be designed to provide good grip on the object, to which the EL wire 502 is to be coupled. In the embodiments shown, the front portion of the coupler 500 may include a jaw 504. Each jaw 504 may include a first portion and second portion 505A and 505B. The first and second portions 505A and 505B of the jaw 504 may be cooperatively engaged. The first and second portions of the jaw 505A and 505B may be designed to provide enhanced grip on the object to which to EL wire 502 is to be coupled. For example, the first and the second portions of the jaw 505A and 505B may include a set of pointed teeth facing the set of pointed teeth of the other portion. The teeth may be serrated to further enhance grip on some objects. The first and second portions of the jaw 505A and 505B may be otherwise designed to provide enhanced grip.

The coupler 500 may also include a spring 506 and two levers 508A and 508B. The spring may be connected to only one portion of the jaw or to both. By pressing the levers 508A and 508B the spring 506 may be flexed and expanded outwardly. When the levers 508A and 508B are released, the spring 506 may return to its contracted state. When contracted, the spring 506 may fasten or lock together the two portions of the jaw 505A and 505B. When the levers are pressed together, the spring 506 may expand outwardly, unlocking the two portions of the jaw 505A and 505B, and causing the jaw 504 to open. A portion of the material or object to which the EL wire 502 is to be fastened may be placed between the two rows of teeth 505A and 505B. Once the material or object is in place, the levers 508A and 508B may be released locking first and the second portion of the jaw 505A and 505B together, and fastening the coupler 500 to the object or material. In the embodiment shown, the jaw 504 may be locked or released as desired.

In addition, according to further embodiments of the device of the present invention, the couplers 500 may also be locked to a desired location along the EL wire 502. For example, the EL wire 502 may be passed through the spring 506. The spring 506 may be designed, such that when in contracted mode (e.g. released) the coils of the spring 506 may press onto the EL wire 502, so as to lock the coupler 500 to the EL wire 502. Alternatively, the spring 506 may also press the EL wire 502 against an object, for example against a portion of the coupler 500, with sufficient force, so as to lock the coupler to the EL wire 502. Thus, the coupler 500 may be locked to a specific location along the EL wire 502. The coupler 500 may be moved to a different location along the EL wire 502, by pressing the levers 508A and 508B, causing the spring 506 to expand, and releasing the coupler 500. The coupler 500 may then be freely moved the coupler 500 to a desired location along the EL wire 502. Once the coupler 500 is positioned at a desired location, the levers 508A and 508B may be released, locking the coupler 500 at the desired location along EL wire 502. This process may be repeated as necessary.

The coupler discussed above is purely exemplary in nature. It should be noted that the present invention is not limited to any one particular coupler design, and that rather, many other couplers may be used to couple the EL wire in accordance with some embodiments of the present invention, to an object or a material. In addition, in accordance with further embodiments of the present invention, the couplers may or may not be moved, positioned and repositioned along the EL wire.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A device comprising:
an electroluminescent wire; and
a casing to house at least a portion of said electroluminescent wire and to allow at least partial extraction of said electroluminescent wire out of said casing and at least partial retraction of said electroluminescent wire into said casing.

2. A device according to claim 1, wherein at least a portion of said electroluminescent wire is adapted to extend out of said casing.

3. A device according to claim 1, comprising a retraction mechanism adapted to retract at least a portion of said electroluminescent wire into said casing.

4. A device according to claim 2, comprising an extension mechanism adapted to extend at least a portion of said electroluminescent wire out of said casing.

5. A device according to claim 3, wherein said retraction mechanism comprises a spring.

6. A device according to claim 5, wherein said spring is a flat spring.

7. A device according to claim 5, wherein said electroluminescent wire is retracted into said casing in response to an unwinding of said spring.

8. A device according to claim 7, wherein said spring is adapted to retract substantially the full length of said electroluminescent wire into said casing.

9. A device according to claim 1, further comprising at least one power supply unit adapted to supply power to said electroluminescent wire.

10. A device according to claim 9, wherein said at least one power supply unit is located within said casing.

11. A device according to claim 10, wherein said at least one power supply unit is located within a power unit compartment, and wherein said power unit compartment is accessible by a user.

12. A device according to claim 11, wherein said at least one power supply is connected to said electroluminescent wire substantially continuously during extension and/or retraction of said electroluminescent wire.

13. A device according to claim 1, further comprising a power switch adapted to electrically connect said electroluminescent wire to a power source when in a first state and electrically disconnect said electroluminescent wire from said power source when in a second state.

14. A device according to claim 1, further comprising an intensity control unit operatively connected to a power supply unit and adapted to control power delivered from the power supply unit to said electroluminescent wire.

15. A device according to claim 1, further comprising at least one coupler adapted to couple at least a portion of said electroluminescent wire to one or more objects.

16. A device according to claim 15, wherein said at least one coupler is adapted to be placed at a variable location along said electroluminescent wire.

17. A device comprising:
a first electroluminescent wire;
a casing to house at least a portion of said first electroluminescent wire and to allow at least partial extraction of said first electroluminescent wire out of said casing and at least partial retraction of said electroluminescent wire into said casing.

18. A device according to claim 17, wherein said device is adapted to receive a second electroluminescent wire.

19. A device according to claim 18, wherein said second electroluminescent wire is serially connected to said electroluminescent wire.

20. A device according to claim 19, wherein said first electroluminescent wire comprises at least one set of output terminals serially connectable to a corresponding set of electrodes of said second electroluminescent wire.

21. A device according to claim 20, wherein second additional electroluminescent wire is connected in parallel to said first electroluminescent wire.

22. A device according to claim 21, wherein a power supply unit of said device comprises a first set of output terminals and a second set of output terminals, and wherein said first set of output terminal is connected to said first electroluminescent wire and said second set of output terminals is connectable in parallel to said second electroluminescent wire.
